(19) United States
(12) Patent Application Publication
(10) Pub. No.: US 2009/0110059 A1
(43) Pub. Date: Apr. 30, 2009

(54) METHOD AND SYSTEM FOR TRANSMITTING END-USER ACCESS INFORMATION FOR MULTIMEDIA CONTENT

(75) Inventors: Theodore S. Rzeszewski, Wheaton, IL (US); Eiraj Rezania, Kildeer, IL (US)

Correspondence Address: Motorola, Inc.;Law Department, 1303 East Algonquin Road, 3rd Floor, Schaumburg, IL, 60196, US

(73) Assignee: General Instrument Corporation, Horsham, PA (US)

(21) Appl. No.: 11/930,297

(22) Filed: Oct. 31, 2007

(51) Int. Cl. H04N 7/30; H04L 9/00

(52) U.S. Cl. 375/240.2; 375/240.24; 713/176; 375/E07.226

(57) ABSTRACT

A system, method and devices for embedding end-user access information, such as digital rights management (DRM) information and/or conditional access (CA) information, in multimedia content, such as broadcast video content, and transmitting or distributing the multimedia content, including the end-user access information, to one or more end user devices, such as multimedia content processing (set-top) devices and mobile devices. The methods, systems and devices also involve receiving and decoding the transmitted multimedia content, including extracting end-user access information from the multimedia content and using the end-user access information to allow or deny access to the multimedia content by the end user device. The end-user access information is embedded in the multimedia content in a manner that reduces or even eliminates the need to also transmit end-user access information separately or along with the associated multimedia content.

### BACKGROUND OF THE INVENTION

1. Field of the Invention

The invention relates to transmitting end-user access information, such as digital rights management information, to one or more end user devices. More particularly, the invention relates to transmitting end-user access information to end user devices by embedding end-user access information in multimedia content transmitted to the end user devices.

2. Description of the Related Art

The ability to protect, secure and/or control the distribution of multimedia content to end users and end user devices is an important aspect of the overall distribution methods and systems used by providers of multimedia content. Multimedia content includes video content and/or other content that is broadcast or otherwise transmitted or provided by content providers over transmission channels to end user devices. Content providers suitable for providing multimedia content include cable television service providers, satellite television service providers and other suitable providers of multimedia content. Transmission channels, including broadcast channels, suitable for transmitting or otherwise providing multimedia content to end user devices include cable networks, Internet protocol (IP) networks, wireless networks, satellite networks and other conditional access networks. End user devices suitable for receiving multimedia content include signal converter or decoder (set-top) boxes, and handheld devices, such as smart phones, personal digital assistants (PDAs) and cellular telephones. End user devices typically are configured to demodulate and/or decode the multimedia content, and provide a content stream suitable for viewing and/or recording by the end user device or other appropriate devices connected to the end user device, such as a display device and/or a content recorder.

Conventional methods for protecting multimedia content broadcast or otherwise provided to end users devices typically involve the transmission of digital rights management (DRM) information, conditional access (CA) information and/or control messages and/or other information separate from but associated with the provided multimedia content. For example, conventional DRM methods and systems typical require or involve the transfer of various security “keys” between the content provider and the end user device receiving the associated content. The security keys, which are transmitted separately from the associated content, allow encrypted broadcast content to be decrypted and accessed by the end user device receiving the content associated with the security key or keys.

Also, for example, end user devices that are connected to shared conditional access networks, such as cable television service providers and satellite television service providers, are configured as conditional access control devices compatible with or supported by the particular transmission protocol of the conditional access information, video services and other information from the conditional access source. Such end user devices interpret or decode the conditional access information and use the information to manage conditional access features and other command, control and configuration features applicable to the end user devices. However, such conventional content protection methods and systems typically involve the transmission of access information (i.e., security keys, messages and other protection or security information associated with the actual broadcast content) separate from and in addition to the actual transmitted multimedia content.

Conventional methods exist that embed a watermark in multimedia content using some sort of domain transformation to hide the watermark information in certain areas of the underlying content. The watermark information is used to identify the origin, ownership and/or authenticity of the content.

### BRIEF DESCRIPTION OF THE DRAWINGS

FIG. 1 is a block diagram of a system for transmitting end-user access information for multimedia content to end user devices;

FIG. 2 is a block diagram of the encoder used in the system for transmitting end-user access information for multimedia content to end user devices of FIG. 1;

FIG. 3 is a block diagram of a method for transmitting end-user access information for multimedia content to end user devices;

FIG. 4 is a block diagram of an end user device, such as a multimedia content processing device, for use in a system for transmitting end-user access information for multimedia content to end user devices;

FIG. 5 is a block diagram of a method for decoding multimedia content including end-user access information; and

FIG. 6 is a block diagram of the decoder used in the end user device of FIG. 4.

### DETAILED DESCRIPTION

In the following description, like reference numerals indicate like components to enhance the understanding of the system and method for transmitting end-user access information for multimedia content through the description of the drawings. Also, although specific features, configurations and arrangements are discussed hereinbelow, it should be understood that such specificity is for illustrative purposes only. A person skilled in the relevant art will recognize that other steps, configurations and arrangements are useful without departing from the spirit and scope of the invention.

The methods, systems and devices described herein involve embedding end-user access information, such as digital rights management (DRM) information and/or conditional access (CA) information, in multimedia content, such as broadcast video content, and transmitting or distributing the multimedia content, including the end-user access information, to one or more end user devices. The methods, systems and devices described herein also involve receiving and decoding the transmitted multimedia content, which includes extracting end-user access information from the multimedia content and using the end-user access information to allow or deny access to the multimedia content. Conventionally, DRM information and other end-user access information is transmitted to end user devices separately from the multimedia content for which access is sought. In the methods and systems described herein, end-user access information is embedded in the multimedia content in a manner that reduces or even eliminates the need to also transmit end-user access information separate from the associated multimedia content. The inclusion of end-user access information in the multimedia content provides an advantageous balance between the efficient use of multimedia content network resources and the processing requirements of end user devices receiving the end-user access information included in the multimedia content. End-user access information is used to allow or deny end users and/or end user devices access to the underlying multimedia content or other multimedia content associated with the end-user access information.

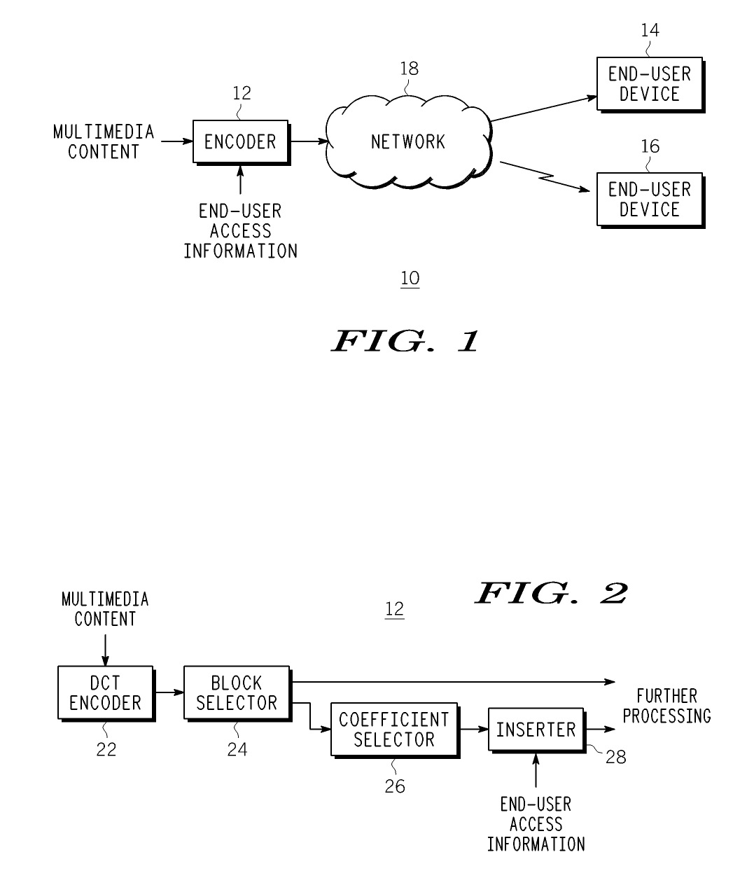

Referring now to FIG. 1, shown is a block diagram of a conventional system 10 for transmitting end-user access information for multimedia content to end user devices. The system 10 includes a multimedia content provider/server (not shown) for providing multimedia content, an end-user access information provider (not shown) for generating end-user access information, an encoder or inserter 12 and a plurality of end user devices 14, 16 configured to receive multimedia content and end-user access information. The end user devices 14, 16 can be coupled to the multimedia content provider and the end-user access information provider via one or more networks 18, such as an Internet protocol (IP) network or wireless network. It should be understood that the system 10 includes other devices and components that are used for the operation of other features and functions of the system 10 not specifically described herein.

The multimedia content and/or the end-user access information can be provided by any suitable transmission source of multimedia content, such as over-the-air broadcasters, from a cable television plant, satellite or terrestrial broadcast station or other multimedia service provider. Also, the multimedia content and the end-user access information can be provided by the same source or provider, or by any one or more different sources. The multimedia content can be any suitable multimedia content, such as broadcast video, including movies, programming events and/or other multimedia content that is distributed, e.g., as one or more programming streams from a broadcast source or other suitable multimedia content source. The multimedia content typically is a plurality of digital signals formatted according to a suitable standard, such as the MPEG (Moving Picture Experts Group) 2 or MPEG 4 standard, and multiplexed into a data stream that is modulated on a carrier using quadrature amplitude modulation (QAM) or other suitable modulation technique.

The end-user access information can be any suitable information that allows (or denies) end users and/or end user devices to access and/or control associated multimedia content. For example, end-user access information can include, but is not limited to, digital rights management (DRM) information, such as security and/or control keys and/or messages, encryption and/or decryption keys, digital signature and certificate information, end user authentication information, and/or any other DRM information that allows (or denies) end user access to multimedia content, including access information in accordance with one or more DRM standards, such as the Open Mobile Alliance (OMA) standard and one or more of the Digital Video Broadcasting (DVB) standards, including DVB-H for handheld or mobile end user devices. End users access information also can include, but is not limited to, conditional access (CA) information (CAI), such as one or more scrambler, descrambler and/or control keys and/or messages, encryption and decryption control keys and/or words, entitlement control and/or entitlement management information, and/or any other access information used within a conditional access system to protect content and/or allow access to and/or control of protected content by one or more end users, including access information in accordance with one or more conditional access system standards, such as Digital Video Broadcasting—Conditional Access (DVB-CA).

The network 18 can be any communication network or network server arrangement suitable for transmitting multimedia content and/or end-user access information to one or more of the end user devices 14, 16. For example, the network 18 can be or include the Internet or an Internet protocol (IP) based network, or other suitable public network. The network 18 also can include a computer network, a web-based network or other suitable wired or wireless network or network system, wired or wireless wide area network (WAN), local area network (LAN) or wireless local area network (WLAN), such as a residential network, or other suitable network or network system.

One or more of the end user devices 14, 16 can be any suitable device that can connect, communicate and exchange multimedia content and/or end-user access information with the network 18 or a network device within the network. The connection between the network 18 and one or more of the end user devices 14, 16 can be a wired connection, such as a broadcast channel or other suitable wired connection, as shown generally between the network 18 and one of the end user devices 14. Alternatively, the connection between the network 18 and one or more of the end user devices can be wireless, as shown generally between the network 18 and the end user device 16. Although not shown, the network 18 typically includes one or more network devices, such as routers and/or computers, for establishing a wired or wireless connection with one or more of the end user devices 14, 16.

One or more of the end user devices 14, 16 can be any device suitable for receiving, viewing, storing, executing, consuming and/or otherwise processing multimedia content and end-user access information. For example, one or more of the end user devices 14, 16 can be any digital video recorder (DVR) or digital video server (DVS) device, including any signal converter or decoder (set-top) box with internal and/or external recording capabilities and local and/or remote storage, which often are referred to as personal video recorder (PVR) devices. Other suitable end user devices include a residential gateway, a home media server system, a digital video disk recorder, a computer, a television with built-in or added-on multimedia content receiving and/or storing capability, or other suitable computing devices and video processing devices, including internet protocol (IP), satellite and cable digital video recorders, and home area network (HAN) devices and systems. Also, one or more of the end user devices 14, 16 can be any suitable mobile or handheld end user device. For example, one or more of the end user devices 14, 16 can be a cellular telephone, a smart phone, a personal digital assistant (PDA), a digital music player and/or other handheld mobile device. Also, one or more of the end user devices 14, 16 can be a laptop personal computer (PC), a notebook PC and/or other mobile computing device with communications capability.

In general, within the system 10, multimedia content is broadcast or otherwise transmitted, via the network 18, to one or more of the end user devices 14, 16. Similarly, end-user access information associated with at least a portion of the transmitted multimedia content, such as DRM information, is transmitted to one or more of the end user devices 14, 16, via the network 18. In some instances, some end-user access information and other information can be transmitted from one or more of the end user devices 14, 16 to the network 18 and/or to one or more of the multimedia content service provider and the end-user access information provider.

More specifically, the multimedia content and/or the end-user access information can be transmitted or otherwise provided to one or more end user devices 14, 16, via the network 18, using any suitable connection or connections, e.g., one or more coaxial cables and/or optical fibers, including a Hybrid Fiber Coaxial (HFC) cable system. Other suitable connections include suitable Fiber To The Premises (FTTP) systems, such as Fiber To The Curb (FTTC) or Fiber To The Home (FTTH), or over any suitable number of digital subscriber line systems (xDSL). Also, the multimedia content and/or the end-user access information can be provided wirelessly, e.g., via over-the-air-broadcast from a satellite service provider or other suitable multimedia content service provider. Some end user devices, such as home computers and computer-related devices, can receive multimedia content and end-user access information via a computer network, either through a wired connection or wirelessly. Other devices, such as mobile or handheld end user devices, including personal digital assistants (PDAs) and cellular telephones, can receive multimedia content and/or end-user access information wirelessly, via a wireless network. To receive such multimedia content end and/or end-user access information, the end user devices 14, 16 may include one or more receiving components (not shown), such as a radio frequency (RF) tuner, a QAM demodulator, an MPEG stream demultiplexor and/or an end-user access information decryptor or decrypting module.

Depending on the type of multimedia content received, end user devices often must also receive some type of end-user access information associated with the received multimedia content to access, control and/or configure the received multimedia content. For example, the end-user access information may include the necessary authentication and security codes to allow the end user device to access the received multimedia content for consumption, e.g., for playback, execution or other processing. As discussed hereinabove, conventionally, end-user access information is transmitted separately from its associated multimedia content in one or more additional transmissions. Alternatively, end-user access information is transmitted along with its associated multimedia content. However, end-user access information transmitted along with its associated multimedia content typically increases the overall amount of transmitted information.

The system 10 also includes the encoder 12, which is coupled to the network 18. The encoder 12 can be part of any suitable multimedia encoder or video encoder, which can be part of the multimedia content provider and/or the end-user access information provider. Alternatively, the encoder 12 can be external to the multimedia content service provider and/or the end-user access information provider. In general, the encoder 12 is configured to receive multimedia content, to receive end-user access information, and to embed or otherwise incorporate at least a portion of the end-user access information into at least a portion of the multimedia content. In the system 10, the encoder 12 is configured to receive both multimedia content, e.g., from a suitable provider of multimedia content, and end-user access information, e.g., from a suitable provider of end-user access information.

Referring now to FIG. 2, shown is a block diagram of the encoder 12 used in the system 10 for transmitting end-user access information for multimedia content to end user devices. The encoder 12 includes a multimedia content encoder 22, such as a discrete cosine transform (DCT) encoder, a block selector 24, a coefficient selector 26, and an end-user access information inserter 28. The operation of the encoder 12 will be discussed hereinbelow as part of the discussion of a method for transmitting end-user access information for multimedia content to end user devices.

It should be understood that one or more of the components in the encoder 12, including one or more of the multimedia content encoder 22, the block selector 24, the coefficient selector 26 and the end-user access information inserter 28, can be comprised partially or completely of any suitable structure or arrangement, e.g., one or more integrated circuits. Also, it should be understood that the encoder 12 includes other components, hardware and software (not shown) that are used for the operation of other features and functions of the encoder 12 not specifically described herein.

The encoder 12 can be partially or completely configured in the form of hardware circuitry and/or other hardware components within a larger device or group of components. Alternatively, the encoder 12 can be partially or completely configured in the form of software, e.g., as processing instructions and/or one or more sets of logic or computer code. In such configuration, the logic or processing instructions typically are stored in a data storage device (not shown). The data storage device typically is coupled to a processor or controller (not shown), which accesses the necessary instructions from the data storage element and executes the instructions or transfers the instructions to the appropriate location within the encoder 12.

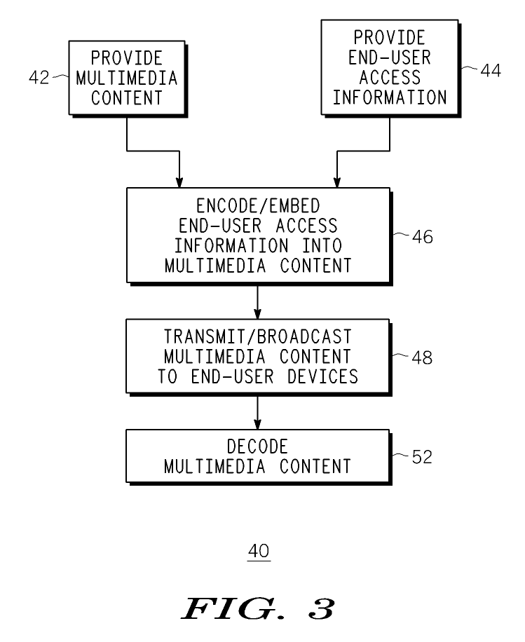

Referring now to FIG. 3, with continuing reference to FIG. 1 and FIG. 2, shown is a flow chart that schematically illustrates a method 40 for transmitting end-user access information for multimedia content to end user devices. The method 40 includes a step 42 of providing multimedia content and a step 44 of providing end-user access information. As discussed hereinabove, multimedia content and/or end-user access information can be provided by any suitable transmission source of multimedia content, such as a cable television plant, satellite or terrestrial broadcast station or other suitable multimedia service provider.

The method 40 includes a step 46 of embedding end-user access information into multimedia content. As discussed hereinabove, in general, for multimedia content, one technique for embedding a watermark in multimedia content uses some sort of domain transformation to hide the watermark information in certain areas of the underlying content. Many domain transformation techniques use frequency domain transformation rather than spatial domain transformation, generally because applying a frequency domain transformation makes it possible to observe certain characteristics of the content that simplifies the manipulation of the information. Typically, the end-user access information is embedded into the multimedia content in a manner that makes the end-user access information invisible or nondiscemable to the end user of the digital media, but without any visible loss of quality of the underlying multimedia content.

For example, for multimedia content that is compressed or otherwise processed using a discrete cosine transform or other frequency domain transformation, information can be embedded into the multimedia content by inserting or replacing one or more of the transform coefficients. Accordingly, for multimedia content that is compressed in this manner, end-user access information can be embedded into the multimedia content by replacing one or more of the transform coefficients, e.g., one or more of the DCT coefficients, with end-user access information.

Multimedia content often is coded and transmitted using a block-based video compression encoder, such as an MPEG encoder. In this manner, the multimedia content is encoded as a plurality of coded blocks using a discrete cosine transform or other suitable transform, which, in general, transforms each block of content from the spatial domain to the spatial frequency domain. In general, each coded block is represented by a plurality or matrix of DCT coefficients. The matrix of DCT coefficients represents the DC (zero frequency) component and a number of AC (spatial frequency) components of the single block portion of the multimedia content. For example, for a typical 8×8 block size of multimedia content pixel information, the discrete cosine transformed signal typically includes an 8×8 array of DCT coefficients (1 DC coefficient and 63 AC coefficients) that represent the frequency components of the pixel information.

As just discussed, for multimedia content that is processed using a discrete cosine transform or other suitable transform, end-user access information can be embedded into the multimedia content by replacing one or more of the transform coefficients (e.g., the DCT coefficients) with end-user access information. Typically, the number of DCT coefficients that are replaced with end-user access information is below that which would visibly affect the underlying multimedia content. Also, replacing the higher order (least significant) DCT coefficients tends to reduce the visible impact or effect of replacing DCT coefficients of the multimedia content.

The step 46 of embedding end-user access information into the multimedia content can involve inserting end-user access information into a portion of one or more DCT coefficients, or completely replacing one or more DCT coefficients with end-user access information. Typically, DCT coefficients each have 8 or 16 bits of information. Thus, the amount of end-user access information that is to be embedded in the multimedia content will affect how many DCT coefficients are modified or replaced with end-user access information. Also, as discussed hereinabove, modifying or replacing the higher order or least significant DCT coefficients, i.e., the DCT coefficients that contribute the least to the overall image of the multimedia content, allows more DCT coefficients to be modified or replaced while still reducing the overall effect of modifying or replacing DCT coefficients on the overall multimedia content image.

For example, using the encoder 12, multimedia content received by the encoder 12 is received by an encoding element, such as a DCT encoder 22. It should be understood that other suitable encoding elements for encoding multimedia content can be used instead of a DCT encoder. As discussed hereinabove, the DCT encoder 22 (or other suitable encoding element) typically transforms the multimedia content into a plurality of blocks, with each block being represented by a plurality of coefficients.

The plurality of blocks pass from the encoder 22 to the block selector 24. The block selector 24 selects which of the blocks are to be embedded with end-user access information. Blocks that are not selected to be embedded with end-user access information can be passed directly to further processing. Blocks that are selected to be embedded with end-user access information are passed to the coefficient selector 26. Alternatively, selected blocks and/or blocks not selected can be marked accordingly and all blocks can be passed through to the coefficient selector 26. In such case, the coefficient selector 26 is configured to identify which blocks have been selected for embedding with end-user access information and which blocks were not selected for embedding with end-user access information.

The block selector 24 can select which blocks are to be embedded with end-user access information in any suitable fixed or predetermined manner. For example, the number of blocks selected can be a predetermined percentage of the total number of blocks. Alternatively, the number of blocks selected and/or which blocks are selected can be based on a predetermined algorithm. The selected blocks can be marked, flagged or otherwise identified in a manner suitable for the coefficient selector 26 to determine which blocks have been selected for embedding with end-user access information. Alternatively, the block selector 24 can notify the coefficient selector 26 which blocks have been selected for embedding without marking or flagging the selected blocks, e.g., by providing control information and/or other information to the coefficient selector 26.

The coefficient selector 26 is configured to select which of the coefficients within the selected blocks are to be embedded with end-user access information. The number of coefficients per block and which coefficients within a given block are to be selected for embedding with end-user access information are determined in a fixed manner. Alternatively, coefficients can be selected according to a predetermined scheme, or according to one or more suitable predetermined algorithms.

For example, it can be predetermined that every 100 blocks will include end-user access information and/or it can be predetermined that end-user access information will be included in certain fixed coefficient locations, e.g., coefficients 40-50 will include end-user access information. In this manner, the block selector 24 will include a counter that selects every 100th block. Similarly, the coefficient selector 26 will include a counter that locates or selects coefficients 40-50 in the selected block.

Selecting a predetermined block and using predetermined coefficients within the selected block reduces the computing time necessary by the encoder 12 and the overall system 10, including any decoding components in the end user device, as will be discussed in greater detail hereinbelow. That is, every block will not have to be analyzed to determine if end-user access information is embedded therein. Instead, all blocks but the predetermined blocks (e.g., each 100th block) can be processed directly, i.e., without having to be analyzed for possible end-user access information embedded therein. In this manner, every 100th block will have end-user access information embedded therein, and, as discussed hereinabove, in the same fixed coefficient locations.

The coefficient selector 26 can identify coefficients selected for embedding in any suitable manner. For example, the coefficient selector 26 can provide suitable control information to the inserter 28 that identifies which coefficients have been selected for embedding.

Once the coefficient selector 26 selects which coefficients are to be embedded with end user access information, the plurality of blocks pass from the coefficient selector 26 to the inserter 28. The inserter 28 is configured to embed the selected coefficients within the selected blocks with end-user access information. The inserter 28 can insert end-user access information into the selected coefficients in any suitable manner. For example, the inserter 28 can completely replace selected coefficients with end-user access information. Such embedding may include an intermediate step of first zeroing out the selected coefficient, followed by replacing the zeroed out coefficient with end-user access information.

Depending on the amount of end-user access information embedded into the coefficients and the manner in which the end-user access information is embedded into selected coefficients within selected blocks, the end-user access information can be divided among a plurality of coefficients within a given block and/or among the same coefficients across a plurality of blocks. Such embedding of end-user access information typically involves some sort of concatenation of the extracted end-user access information at the decoding end of the overall multimedia content transmission process.

Once the inserter 28 has inserted end-user access information into the selected coefficients within the selected blocks, the blocks are passed on to further processing. This may include initially recombining the blocks selected by the block selector 24 with the blocks that were not selected by the block selector 24 before passing the blocks on to further processing. With respect to further processing, it should be understood that the encoder 12 can include other processing components, hardware and software (not shown) that are used for the operation of other features and functions of the encoder 12 not specifically described herein.

The method 40 also includes a step 48 of transmitting or broadcasting the multimedia content to one or more end user devices 14, 16, e.g., via the network 18. The multimedia content can be transmitted or broadcast to the end user devices 14, 16 in any suitable manner. For example, the multimedia content can be transmitted via an appropriate wired connection, such as a broadcast channel, between the network 18 and one or more of the end user devices 14, 16. Alternatively, the multimedia content can be transmitted wirelessly between the network 18 and one or more of the end user devices 14, 16.

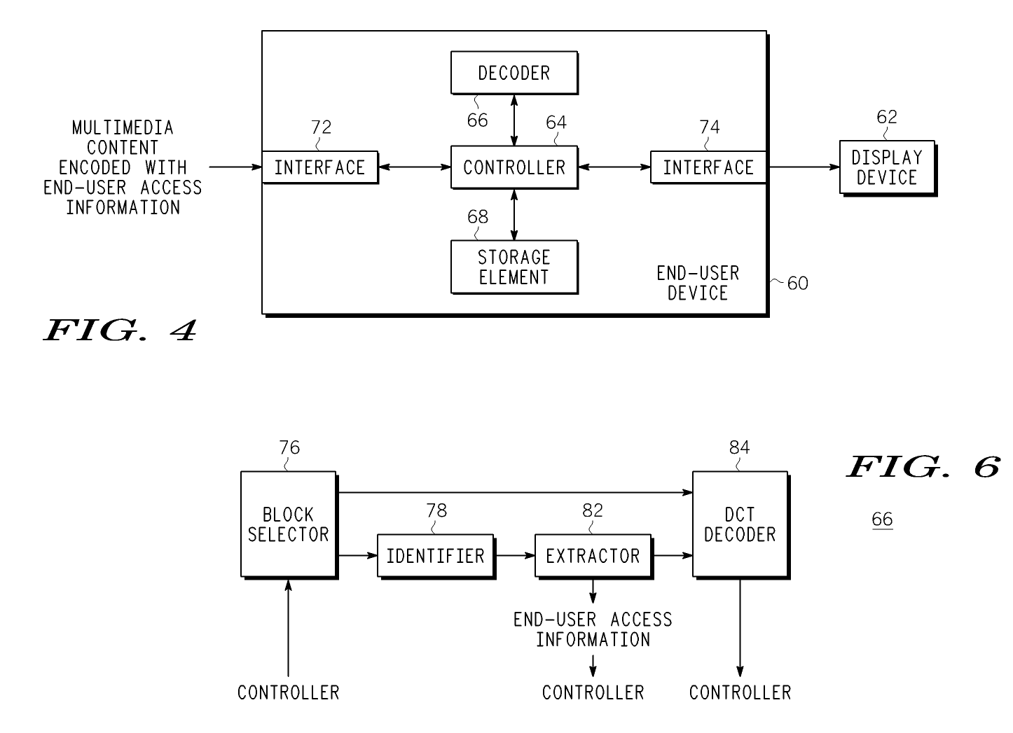

Referring now to FIG. 4, shown is a block diagram of an end user device 60, such as one of the end user devices 14, 16 or other suitable multimedia content processing device, for use in the system 10 for transmitting end-user access information for multimedia content to end user devices. As discussed hereinabove, the end user device 60 can be any device suitable for receiving, viewing, storing, executing, consuming and/or otherwise processing multimedia content and end-user access information. The end user device 60 can be partially or completely any suitable device or subsystem (or portion thereof) for receiving multimedia content from the content source, processing or decoding the received multimedia content, and transmitting or transferring the processed multimedia content to an end user display device 62, such as a television, a stereo, a computer monitor or other suitable display device. Although the display device 62 is shown as a separate component from the end user device 60, it should be understood that the display device 62 and the end user device 60 can be combined or integrated as a single component.

The end user device 60 includes a controller or processor 64 and a decoder 66 coupled to the controller 64. The end user device 60 also can include an optional content storage element or device 68 coupled to the controller 64. In general, the controller 64 processes multimedia content and other information received by the end user device 60. In addition to the content storage element 68, the controller 64 can include at least one type of memory or memory unit (not shown) and a storage unit or data storage unit coupled to the controller for storing processing instructions and/or information received and/or created by the end user device 60. The decoder 66 typically decodes or decompresses the multimedia content to make it suitable for display, e.g., by the end user display device 62. Although the decoder 66 is shown coming after the controller 64 in the component arrangement of end user device 60, it should be understood that the decoder 66 can come before the controller 64, i.e., the multimedia content can be decoded or decompressed prior to further processing by the controller 64.

The end user device 60 also can include one or more input and/or output interfaces for receiving and/or transmitting multimedia content, including multimedia content embedded with end-user access information. For example, the controller 64 and other components in the end user device 60 can be coupled between a first or input interface 72, which receives multimedia content, including multimedia content embedded with end-user access information, and a second or output interface 74, which transfers processed multimedia content, including stored multimedia content, to the end user display device 62. It should be understood that one or more of the interfaces 72, 74 can be a single input/output interface coupled to the controller 64. Also, it should be understood that one or more of the interfaces 72, 74 can be an interface configured to support more than one content source and/or more than one display device.

One or more of the controller 64, the decoder 66, the content storage element 68 and the interfaces 72, 74 can be comprised partially or completely of any suitable structure or arrangement, e.g., one or more integrated circuits. Also, it should be understood that the end user device 60 includes other components, hardware and software (not shown) that are used for the operation of other features and functions of the end user device 60 not specifically described herein.

The end user device 60 can be partially or completely configured in the form of hardware circuitry and/or other hardware components within a larger device or group of components. Alternatively, the end user device 60 can be partially or completely configured in the form of software, e.g., as processing instructions and/or one or more sets of logic or computer code. In such configuration, the logic or processing instructions typically are stored in a data storage device, e.g., the content storage element 68 or other suitable data storage device (not shown). The data storage device typically is coupled to a processor or controller, e.g., the controller 64. The controller accesses the necessary instructions from the data storage element and executes the instructions or transfers the instructions to the appropriate location within the end user device 60.

With respect to the content storage element 68, multimedia content processing devices typically include or have access to a hard drive or other storage element for recording streams of multimedia content, such as video streams broadcast from the multimedia content source. However, the content storage device 68 can be any suitable information storage unit, such as any suitable magnetic storage or optical storage device, including magnetic disk drives, magnetic disks, optical drives, optical disks, and memory devices, including random access memory (RAM) devices and flash memory. Also, although the content storage device 68 is shown within the end user device 60, the content storage device 68 can be located external to the end user device 60 and suitably coupled thereto.

The method 40 also can include a step 52 of decoding the multimedia content. As discussed hereinabove, the end user device 60 receiving multimedia content typically is configured with a decoder (e.g., the decoder 66) that can decompress and/or decode the received multimedia content in a manner that makes the multimedia content suitable for display, playback and/or other processing. As part of the decoding step 52, the end-user access information is read from the multimedia content. However, the end-user access information typically is read from the multimedia content prior to any inverse transformation of the multimedia content being performed. Thus, for end-user access information that was embedded in multimedia content by replacing one or more DCT coefficients, the end-user access information is read out from among the DCT coefficients prior to performing any inverse DCT transform using the DCT coefficients. Such inverse DCT transform typically is required to decode the multimedia content, e.g., for display or other consumption by the end user device 60. The controller 64, the decoder 66 and/or other suitable components within the end user device 60 are suitably configured to look for end-user access information in particular transform coefficient locations (e.g., coefficients 40-50) of particular blocks (e.g., every 100th block). Once the end-user access information has been read out from the multimedia content, the end-user access information can be used by the end user device in an appropriate manner, e.g., to obtain access to associated multimedia content according to one or more end user access applications. For example, the end user can render, store, copy or retransmit the end-user access information.

If end-user access information is included within a given block, the controller 64 will allow decoding of the multimedia content. However, if end-user access information is not included within a given block, the controller 64 stops decoding and/or stops decrypting.

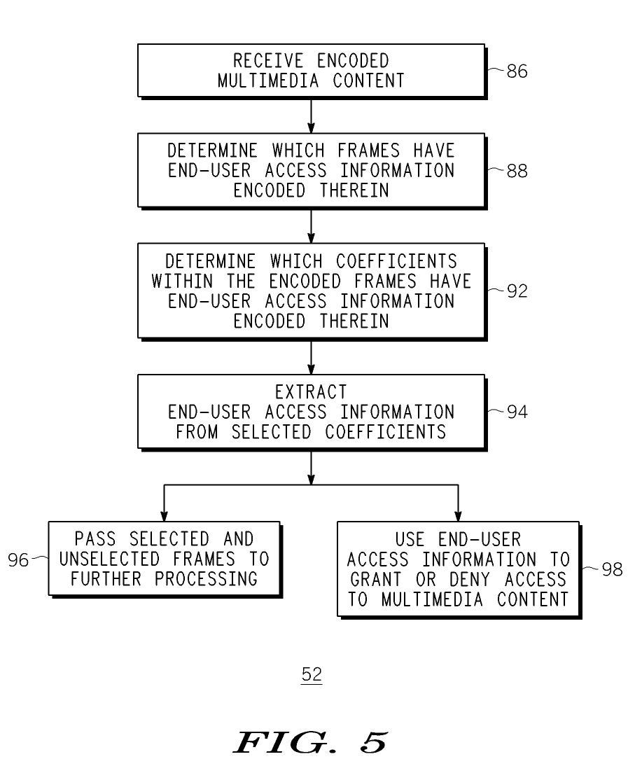

Referring now to FIG. 5, shown is a flow chart of the decoding step 52 used in the method 40 of FIG. 3. Also, referring to FIG. 6, with continuing reference to FIG. 5, shown is a block diagram of the decoder 66 used in the end user device 60 of FIG. 4. The decoder 66 includes a block selector 76, an end-user access information identifier 78, an end-user access information extractor 82, and a multimedia content decoder 84, such as a DCT decoder. The operation of the decoder 66 will be discussed hereinbelow as part of the discussion of the decoding step 52 shown in FIG. 5.

One or more of the components in the decoder 66, including one or more of the block selector 76, the end-user access information identifier 78, the end-user access information extractor 82 and the multimedia content decoder 84, can be comprised partially or completely of any suitable structure or arrangement, e.g., one or more integrated circuits. Also, it should be understood that the decoder 66 includes other components, hardware and software (not shown) that are used for the operation of other features and functions of the decoder 66 not specifically described herein.

The decoder 66 can be partially or completely configured in the form of hardware circuitry and/or other hardware components within a larger device or group of components. Alternatively, the decoder 66 can be partially or completely configured in the form of software, e.g., as processing instructions and/or one or more sets of logic or computer code. In such configuration, the logic or processing instructions typically are stored in a data storage device (not shown). The data storage device typically is coupled to a processor or controller (e.g., the controller 64 shown in FIG. 4), which accesses the necessary instructions from the data storage element and executes the instructions or transfers the instructions to the appropriate location within the decoder 66.

As shown in FIG. 5, the decoding step 52 includes a step 86 of receiving encoded multimedia content. At least a portion of the encoded multimedia content received by the end user device 60 is transmitted or transferred from the controller 64 to the decoder 66. As discussed hereinabove, at least a portion of the encoded multimedia content typically is in the form of a plurality of blocks each represented by a plurality of coefficients, such as DCT coefficients.

The encoded multimedia content transferred from the controller to the decoder 66 is received by the block selector 76. The decoding step 52 includes another step 88 of determining or identifying which blocks are embedded with end-user access information. The block selector 76 performs such determination or identification.

The block selector 76 identifies embedded blocks in a suitable predetermined or fixed manner, depending on the predetermined or fixed manner in which the blocks were selected for embedding by the block selector 24 in the encoder 12. As discussed hereinabove, the blocks selected for embedding can be marked, flagged or otherwise identified. Accordingly, the block selector 76 is configured to identify the embedded blocks based on the particular manner in which the embedded blocks were selected. Alternatively, the block selector 76 can include or receive appropriate identification information and/or other appropriate information associated with the received blocks that allows the block selector 76 to determine which blocks have been embedded. For example, if every 100 blocks includes end-user access information embedded therein, the block selector 76 will either have a counter or be pre-configured to count every 100 blocks.

Blocks that are not identified by the block selector 76 as embedded blocks can be passed directly from the block selector 76 to the multimedia content decoder 84. Blocks that are identified by the block selector 76 as blocks embedded with end-user access information are passed to the identifier or coefficient identifier 78. Alternatively, all blocks, i.e., embedded blocks and non-embedded blocks, can be marked accordingly by the block selector 76 and passed through to the coefficient identifier 78. In such case, the coefficient identifier 78 can be configured to identify which blocks have been identified as embedded blocks and which blocks have not been identified as embedded blocks.

The decoding step 52 includes another step 92 of determining or identifying which coefficients within the identified blocks are embedded with end-user access information. Once the embedded blocks have been identified, the blocks are passed to the coefficient identifier 78. The coefficient identifier 78 is configured to determine which of the coefficients within a given block are embedded with end-user access information. The coefficient identifier 78 can identify embedded coefficients in any suitable predetermined or fixed manner.

For example, the coefficient identifier 78 can include or receive appropriate identification information and/or other appropriate information that allows the coefficient identifier 78 to identify embedded coefficients. Alternatively, the coefficient identifier 78 can be configured to look at particular coefficients within selected blocks for end-user access information. For example, if coefficients 40-50 of selected blocks include end-user access information embedded therein, the coefficient identifier 78 will either have a counter or be pre-configured to identify coefficients 40-50. The manner in which the coefficient identifier 78 identifies end-user access information depends on the manner in which the particular coefficients were embedded by the encoder 12. However, the identifier 78 does not read the actual coefficient values or identify coefficients based on their actual values.

The decoding step 52 includes another step 94 of extracting end-user access information from selected or identified coefficients. Once the embedded coefficients of the embedded blocks have been identified, the blocks are passed to the extractor 82. The extractor 82 is configured to remove or extract the end-user access information from the coefficients identified by the identifier 78 as having end-user access information embedded therein. The extractor 82 is configured to extract end-user access information from identified coefficients in any suitable manner, depending on the manner in which the coefficients were embedded with the end-user access information.

Upon extracting end-user access information from a particular coefficient, the extractor 82 can leave the coefficient unchanged, i.e., leave the coefficient with the end-user access information embedded therein. Alternatively, the extractor 82 can zero out the coefficient, i.e., replace the coefficient with a value of zero, or replace the coefficient value with a predetermined value. Alternatively, the extractor 82 can replace the coefficient with an interpolated value, e.g., based on the values of adjacent and/or nearby coefficients. The extractor 82 then passes the end-user access information to the controller 64.

The decoding step 52 includes another step 96 of passing selected and non-selected blocks to further processing. Once the extractor 82 has extracted end-user access information from the blocks selected by the block selector 76 and the coefficients identified by the identifier 78, the blocks are passed to further processing, such as to a multimedia content decoder, such as the DCT decoder 84. Also, the blocks not selected by the block selector 76 are passed to the DCT decoder 84 or other appropriate multimedia content decoder. The DCT decoder 84 transforms the block coefficients back into a plurality of blocks, or other form of multimedia content, suitable for use by the end user device 60. The DCT decoder 84 then passes the plurality of blocks back to the controller 64.

As discussed hereinabove, by selecting a predetermined block and using predetermined coefficients within the selected block to embed end-user access information therein reduces the computing time necessary by the overall system 10, including the decoder 66. The decoder 66 does not have to analyze every block to determine if end-user access information is embedded somewhere therein and does not have to analyze every coefficient within selected blocks to determine if end-user access information is embedded therein. Instead, all blocks but the predetermined blocks (e.g., each 100th block) do not have to be processed by the decoder 66.

The decoding step 52 includes another step 98 of using the end-user access information to allow or deny the end user device 60 access to the multimedia content. As discussed hereinabove, end-user access information can be DRM information, CA information and/or any other type of information that can be used to allow or deny an end user device 60 (or other end user device) access to multimedia content. The multimedia content to be accessed can be the underlying multimedia content from which the end-user access information was extracted. Alternatively, the multimedia content to be accessed can be other multimedia content associated with the extracted end-user access information.

The processing involved in allowing or denying the end user device 60 access to the multimedia content can be performed by the controller 64 or other suitable component or components within the end user device 60. Alternatively, such processing can be performed by a suitable component or components external to the end user device 60.

Typically, as part of the access determination process, the controller 64 and/or other component may have to concatenate the extracted end-user access information to derive the appropriate end-user access information. Such concatenation is likely especially in cases where portions of end-user access information were embedded across multiple coefficients and/or across multiple blocks. That is, the 8 or 16 bit quantities in 2 or more locations may be combined together to generate larger words. Alternatively, portions of 8 or 16 bit quantities (e.g., 2 bits) may be combined together to generate larger words as well.

The methods shown in FIG. 3 and in FIG. 5 described herein may be implemented in a general, multi-purpose or single purpose processor. Such a processor will execute instructions, either at the assembly, compiled or machine-level, to perform that process. Those instructions can be written by one of ordinary skill in the art following the description of FIG. 3 and FIG. 5 and stored or transmitted on a computer readable medium. The instructions may also be created using source code or any other known computer-aided design tool. A computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), packetized or non-packetized wireline or wireless transmission signals.

It will be apparent to those skilled in the art that many changes and substitutions can be made to the system and method for transmitting end-user access information for multimedia content herein described without departing from the spirit and scope of the invention as defined by the appended claims and their full scope of equivalents.

The methods described herein also can be implemented using one or more storage media, wherein the content stored thereon includes end-user access information.

1. A device for embedding multimedia content with end-user access information, comprising:
an encoder configured to transform at least a portion of the multimedia content into a plurality of blocks represented by a plurality of coefficients;
a block selector coupled to the encoder and configured to select a predetermined set of blocks from among the plurality of blocks that are to be embedded with end-user access information;
a coefficient selector coupled to the block selector and configured to select a predetermined set of coefficients within a selected block that are to be embedded with end-user access information; and
an inserter coupled to the coefficient selector and configured to insert end-user access information into the selected coefficients of the selected blocks of the multimedia content,
wherein at least a portion of the end-user access information allows access to at least a portion of the multimedia content.

2. The device as recited in claim 1, wherein the coefficient selector selects which coefficients within a selected block are to be embedded with end-user access information based on a fixed location of the coefficient within the block.

3. The device as recited in claim 1, wherein the block selector selects which blocks are to be embedded with end-user access information based on a fixed number of blocks within the plurality of blocks being selected.

4. The device as recited in claim 1, wherein the end-user access information includes at least one of digital rights management (DRM) information and conditional access (CA) information (CAI).

5. The device as recited in claim 1, wherein the encoder is a discrete cosine transform (DCT) encoder.

6. The device as recited in claim 1, wherein the end-user access information includes information in accordance with at least one Digital Video Broadcasting (DVB) standard.

7. An end user device for processing multimedia content, comprising:
a controller configured to receive multimedia content, including multimedia content having end-user access information embedded therein, wherein the received multimedia content includes a plurality of blocks represented by a plurality of coefficients; and
a decoder coupled to the controller for reading end-user access information embedded in the multimedia content, wherein at least a portion of the end-user access information allows access to at least a portion of the multimedia content, wherein the decoder includes
a block selector configured to select a fixed set of blocks from among the plurality of blocks as including at least one coefficient that has end-user access information embedded therein,
an identifier coupled to the block selector and configured to select coefficients having a fixed location within a selected block as being embedded with end-user access information,
an extractor coupled to the identifier and configured to extract end user information from the coefficient identified as having end-user access information embedded therein, and
a multimedia content decoder coupled to the extractor and configured to transform blocks received thereby into multimedia content,
wherein the controller is configured to receive end-user access information from the extractor and configured to allow or deny access by the end user device to at least a portion of the multimedia content received by the end user device based on the end-user access information received from the extractor.

8. The device as recited in claim 7, wherein the multimedia content includes control information indicating which blocks of the plurality of blocks include coefficients having end-user access information embedded therein, and wherein the block selector determines which of the plurality of blocks includes at least one coefficient embedded with end-user access information based on the control information.

9. The device as recited in claim 7, wherein the multimedia content includes control information indicating which coefficients within a given block include end-user access information embedded therein, and wherein the identifier determines which coefficients include end-user access information embedded therein based on the control information.

10. The device as recited in claim 7, wherein at least a portion of the selected blocks are marked, and wherein the block selector determines which of the plurality of blocks includes at least one coefficient embedded with end-user access information based on whether the block is marked.

11. The device as recited in claim 7, wherein at least a portion of the selected blocks includes identification information identifying which coefficients within the block include end-user access information embedded therein, and wherein the identifier determines which coefficients within a selected block are embedded with end-user access information based on the identification information.

12. The device as recited in claim 7, wherein the controller is configured to concatenate at least a portion of the end-user access information received from the extractor, and wherein the controller is configured to allow or deny access by the end user device to at least a portion of the multimedia content received by the end user device based on the concatenated end-user access information.

13. The device as recited in claim 7, wherein the decoder is coupled to the block selector and configured to receive from the block selector blocks not selected as including at least one coefficient embedded with end-user access information.

14. The device as recited in claim 7, further comprising a memory element coupled to the controller for storing at least a portion of the multimedia content received by the end user device.

15. A device for decoding multimedia content, wherein the multimedia content includes a plurality of blocks represented by a plurality of coefficients, comprising:
a block selector configured to receive the plurality of blocks and configured to select a fixed set of blocks from among the plurality of blocks as including at least one coefficient that has end-user access information embedded therein,
an identifier coupled to the block selector and configured to select coefficients having a fixed location within a selected block as being embedded with end-user access information,
an extractor coupled to the identifier and configured to extract end user information from the coefficient identified as having end-user access information embedded therein,
wherein at least a portion of the end-user access information allows access to at least a portion of the multimedia content.

16. The device as recited in claim 15, further comprising a controller coupled to the extractor and configured to receive multimedia content, wherein the controller is configured to allow or deny access to at least a portion of the multimedia content based on the end-user access information received from the extractor.

17. The device as recited in claim 15, further comprising a multimedia content decoder coupled to the extractor and the block selector, wherein the multimedia content decoder is configured to transform blocks received thereby into multimedia content.

18. The device as recited in claim 15, wherein the multimedia content includes a plurality of blocks represented by a plurality of discrete cosine transform (DCT) coefficients, and wherein the multimedia content decoder is a DCT decoder.

19. The device as recited in claim 15, wherein the end-user access information includes at least one of digital rights management (DRM) information and conditional access (CA) information (CAI).

20. The device as recited in claim 15, wherein the end-user access information includes information in accordance with at least one Digital Video Broadcasting (DVB) standard.
